(19) United States
(12) Patent Application Publication
(10) Pub. No.: US 2017/0089601 A1
(43) Pub. Date: Mar. 30, 2017

(54) MIXED INTEGER OPTIMIZATION BASED SEQUENCING OF A SYSTEM OF CHILLERS

(71) Applicant: NEC Laboratories America, Inc., Princeton, NJ (US)

(72) Inventors: Rakesh PATIL, SAN FRANCISCO, CA (US); Ratnesh SHARMA, FREMONT, CA (US)

(21) Appl. No.: 15/279,401

(22) Filed: Sep. 28, 2016

Related U.S. Application Data
(60) Provisional application No. 62/235,001, filed on Sep. 30, 2015.

(51) Int. Cl. F24F 11/00; G05B 13/02

(52) U.S. Cl. CPC F24F 11/006; F24F 11/0012; F24F 11/008; G05B 13/026; F24F 2011/0061; F24F 2011/0075; F24F 2011/0058; F24F 2011/0013; G05B 2219/2614

(57) ABSTRACT

Aspects of the present disclosure describe methods and systems for improved control of chillers used in—for example—HVAC applications.

### TECHNICAL FIELD

This disclosure relates generally to systems and methods for operating systems of chillers which are found in contemporary heating, ventilation and air-conditioning (HVAC) installations.

### BACKGROUND

As is known, cooling systems that remove heat from one element and deposit it into another element (i.e., “chillers”) are an important component of contemporary HVAC systems. Due to that function, such chillers are an increasingly important component of data centers—as their round-the-clock operation is crucial to data center operation given the considerable heat produced by servers operating in close proximity to one another. Without such chillers—and their efficient operation—temperatures would quickly rise to levels that would corrupt mission-critical data, destroy hardware, and render inoperable an important aspect of contemporary life.

Accordingly, given their importance to contemporary data center and HVAC operation, methods and structures that contribute to the efficient operation of such chillers would represent a welcome addition to the art.

### SUMMARY

An advance in the art is made according to the present disclosure which describes methods and systems for improved chiller operation. Advantageously, and according to an aspect of the present disclosure, a plurality of chillers comprising an overall chilling system are operatively selected sequenced and dispatched according to one or more operating strategies including performance curves based, minimum cost based, resilient operation based, and device runtime rules based.

Advantageously, methods and systems according to the present disclosure optimize the sequencing of chillers to attain certain goals. For example, to minimize energy consumption, performance curves of all the chillers in a system are utilized in an optimization framework to sequence those chillers exhibiting the greatest energy efficiency. Similarly, if reliable operation and runtime of the chillers are a concern such constraints are included in the optimization to obtain chiller sequencing strategy(ies) that satisfy those constraints.

By incorporating specific goals such as minimizing energy consumption, minimizing operating costs, minimizing return on initial costs, reliability of operation—among others—methods and systems according to the present disclosure facilitate the operation of a chilling system such that greater commercial value may be realized.

In sharp contrast to prior art systems that determine chiller operation and sequencing of chillers at the time of installation, methods and systems according to the present disclosure my advantageously select, sequence and operate a series of chillers as operational conditions and requirements change—in near real time.

### BRIEF DESCRIPTION OF THE DRAWING

A more complete understanding of the present disclosure may be realized by reference to the accompanying drawing in which:

FIG. 1 is a schematic block diagram illustrating a prior art 4 chiller system;

FIG. 2 is a schematic flow diagram depicting an overview of process(es) according to an aspect of the present disclosure;

FIG. 3 is a schematic flow diagram depicting chiller system sequencing and dispatch strategies according to an aspect of the present disclosure; and

FIG. 4 is a schematic block diagram depicting an exemplary computer system for sequencing and dispatching chiller system and generating/determining strategies according to an aspect of the present disclosure; and

FIG. 5 is a schematic block diagram depicting an exemplary chilling system and plurality of chillers controlled by a computer system according to an aspect of the present disclosure.

The illustrative embodiments are described more fully by the Figures and detailed description. Inventions according to this disclosure may, however, be embodied in various forms and are not limited to specific or illustrative embodiments described in the Figures and detailed description

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGs comprising the drawing are not drawn to scale.

By way of some additional background, we again note the importance of chillers in contemporary society. More particularly, the development and operation of powerful chillers and associated HVAC systems has allowed modern data centers to install highly concentrated server clusters—particularly racks of blade servers. Like many consumer and industrial air conditioners, chillers consume immense amounts of electricity and oftentimes require dedicated power supplies and significant portions of annual energy budgets. In fact, chillers may oftentimes consume the largest percentage of a data center's electricity.

Manufacturers and installers also have to account for extreme conditions an variability in cooling loads. This requirement has resulted in chillers that are oftentimes oversized—leading to inefficient operation.

As is known, chillers require a source of water—preferably pre-cooled to reduce energy required to lower its temperature further. This water—after absorbing heat generated from computer (and other) operation—is cycled through an external cooling tower allowing heat to dissipate. Proximity to cold water sources has led many new data centers being situated along rivers in colder climates—such as the Pacific Northwest. The chillers themselves—along with integrated heat exchangers—are located outside of the data center(s)—usually on rooftops or side lots.

Manufacturers have approached next-generation chiller design in a number of ways. For large-scale systems, bearing-less designs significantly improve power utilization given that a majority of chiller inefficiency results from energy loss via friction in the bearings. Smaller systems use smart technologies to rapidly turn a chiller compressor on and off—letting it work efficiently at from 10% to 100% of capacity depending upon workload.

Typical contemporary multiple chiller systems are generally operated as follows. A sequence of operation is determined at the time of installation of the chillers. This determined sequence may then be rotated amongst the chillers where different individual chillers become the “lead” or master chiller that provides a base cooling load. Additional chillers are scheduled based on load variations with new chillers being turned on or off depending on demand (See, e.g., www.trane.com/commercial/north-america/en/controls/HVAC-equipment-controls/tranelontalk-controllerschill-control-ch530.html; and LBNL Facilities Master Specificatoins: SECTION 019113—General Commissioning Requirements, Sample Sequence of Operation).

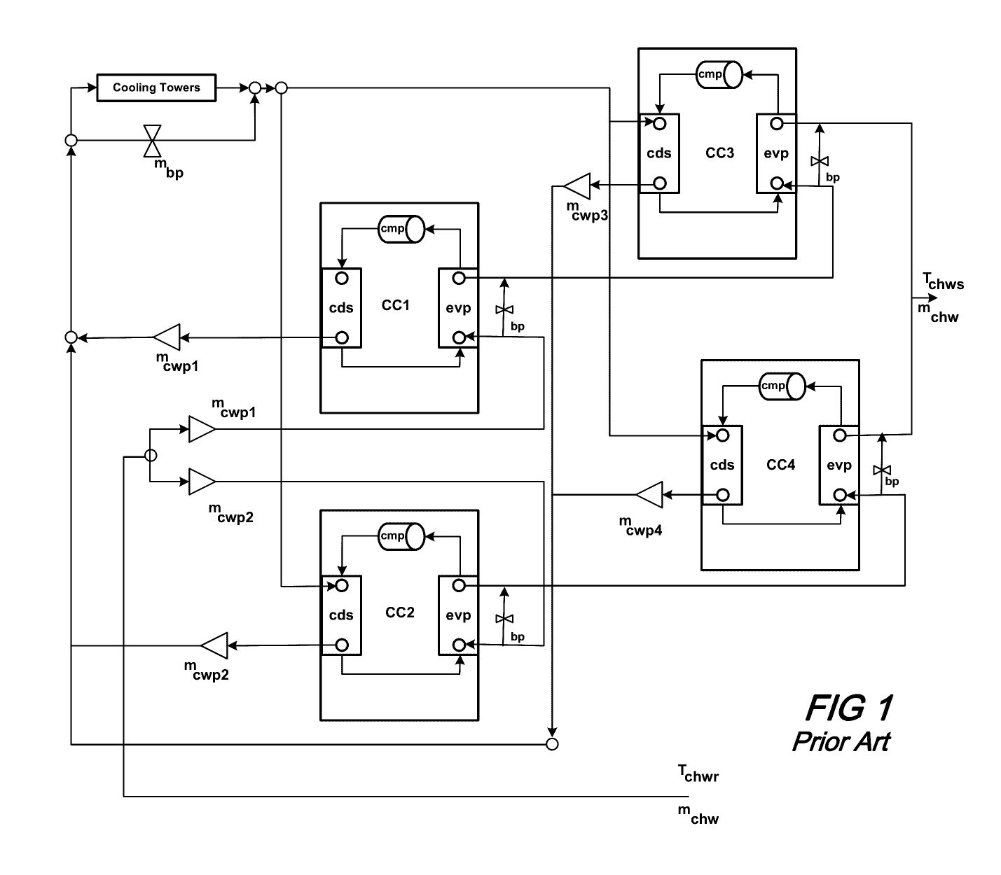

Turning now to FIG. 1, there is shown a schematic block diagram of a prior art 4-chiller system that may be employed in any of a number of HVAC applications including data center application. Operationally—and as will be readily understood by those skilled in the art—such a system will generally receive water at a given high(er) temperature, cool it and re-circulate it. Such operation has been enhanced in the art by scheduling the chillers (See, e.g., A. Torzhkov, P. Sharma, C. Li, R. Toso, and A. Chakraborty, Chiller Plant Optimization—An Integrated Optimization Approach for Chiller Sequencing and Control, 49^{th} IEEE Conference on Decision and Control, 2010).

In such prior art applications, a combined temperature setpoint determination and chiller sequencing methodology is employed. As will be readily appreciated, such an approach cannot be easily implemented in pre-existing installations as it requires the ability to vary the setpoints of water exiting the chillers.

As will now become apparent to those skilled in the art, methods and systems according to the present disclosure solve problems associated with chiller operation by optimizing the sequencing of chillers to attain certain goals. More specifically, in order to minimize energy consumption, performance curves of all the chillers in a system are utilized in an optimization framework to sequence the most efficient chillers. Similarly, where reliable operation and runtime of the chillers are determinative then such reliability data may be employed in the optimization to obtain chiller sequencing that satisfies such reliability constraints.

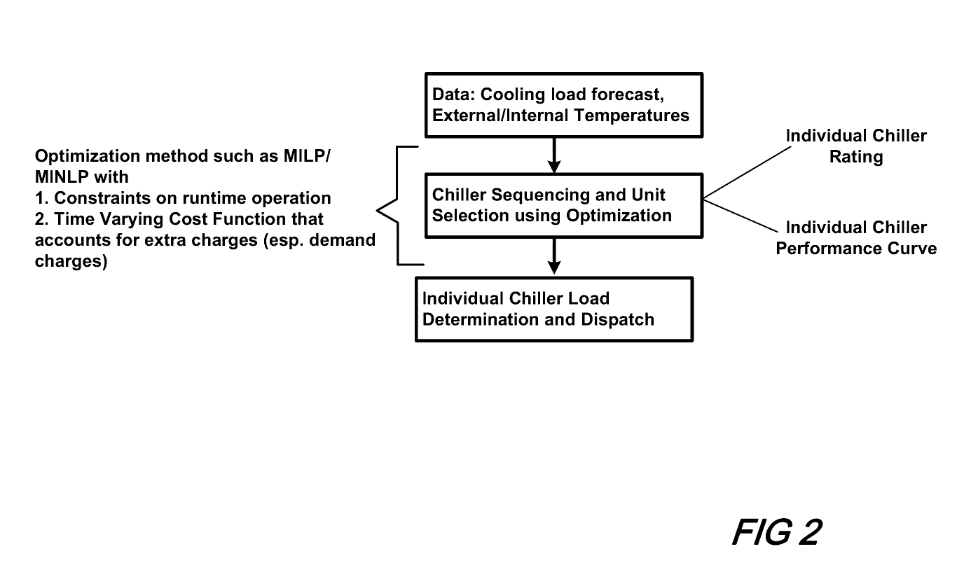

FIG. 2 is a schematic process flow diagram depicting methods according to aspects of the present disclosure. As depicted in that figure, operational data is obtained both with respect to external factors i.e., internal/external temperature(s), thermal mass, cooling load forecast, etc.

That operational data is then used in conjunction with individual chiller rating(s), characteristics, performance curve(s), etc., to generate chiller sequencing and unit selection. As noted above, such chiller selection and sequencing is optimized such that a desired overall system performance is achieved i.e., energy saving, time to chill, etc. As will be readily appreciated, such optimization may advantageously take into consideration factors such as constraints on runtime operation, time varying cost function(s) that account for extra charges such as demand charges, etc.

These data and characteristics are then employed to generate individual chiller load determination (how much an individual chiller is to be employed) and individual chiller dispatch.

As should be apparent to those skilled in the art, our chiller sequencing according to the present disclosure employs data such as cooling load from past days or a forecast for next day(s) along with state variables such as temperature and pressure. The solutions—selection/sequencing/operation of chillers—is based on an optimization scheme which is mixed integer in nature due to the sequencing or unit commitment part of the problem. This optimization advantageously uses the rating and performance curve(s) of each chiller and considers constraints such as uptime and/or downtime for each device and time varying cost functions of the power consumption. The resulting (optimized) sequencing is then used to determine the loading level of each chiller for every time step of a given day.

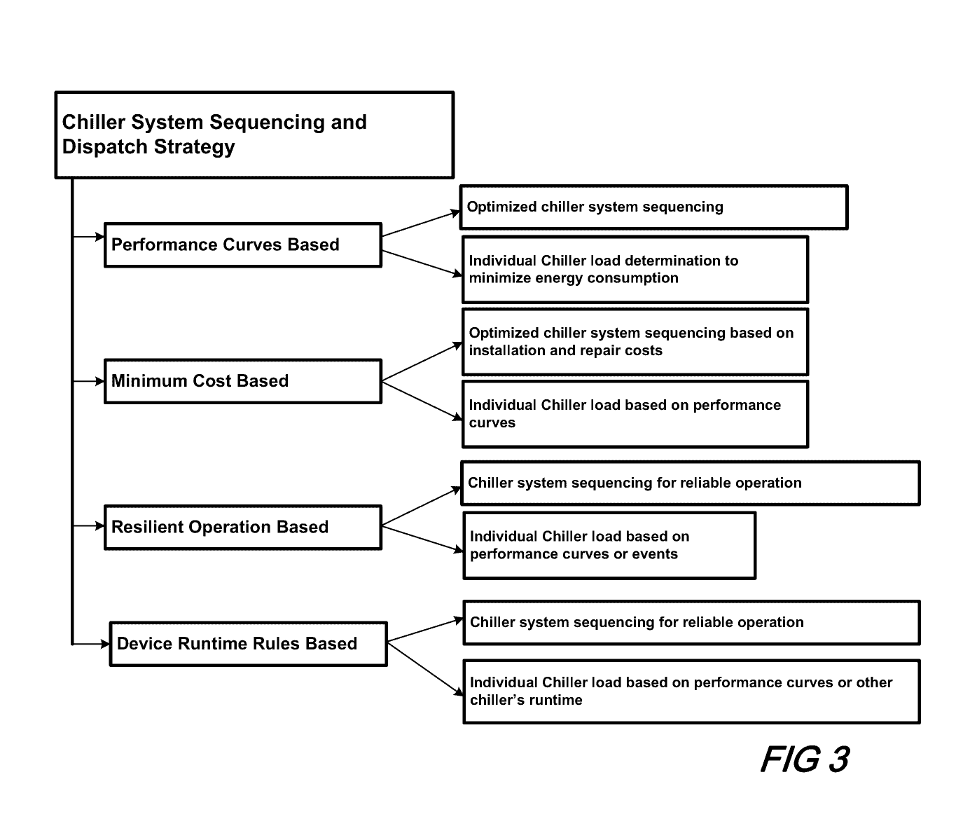

FIG. 3 is a schematic block diagram illustrating the various objectives that may be employed when selecting/sequencing/dispatching/operating chillers according to aspects of the present disclosure. For example, when energy consumption or energy costs (which are different from energy consumption due to the time varying nature of energy costs) are objectives of a minimization goal, the chiller sequencing comprises that optimization objective.

As will be appreciated, when dispatched in this manner, cooling resources are selected/sequenced/dispatched/operated according to performance curves and minimum cost considerations of the individual chillers comprising the overall chilling system. In practice, our method according to the present disclosure will optimize the sequencing of the chillers and then may advantageously consider any load determination(s) made for those device(s).

Furthermore, any dispatch strategy employed may account for reliable operation and/or incorporate constraints based on device runtime. In such a scenario, selection and sequencing is determined according to reliability factors. Once such sequencing is determined, the load of each chiller is then determined using performance curves associated with particular chillers so selected.

As may be observed from FIG. 3, chiller selection/sequencing/dispatch/operation may utilize any of a number of characteristics according to the present disclosure including: performance curves based, minimum cost based, resilient operation based, and device runtime rules based—among others.

As indicated in that figure, performance curves based operation determines an optimized chiller system sequencing wherein individual chiller load determination is made to minimize energy consumption.

Minimum cost based operation determines an optimized chiller system sequencing based on installation and repair costs wherein individual chiller load determination is based on performance curves.

Similarly, resilient operation based operation determines chiller system sequencing for reliable operation wherein individual chiller load based on performance curves or events.

Finally, device runtime rules based operation determines chiller system sequencing for reliable operation wherein individual chiller load is based on performance curves or other chiler's runtime characteristics.

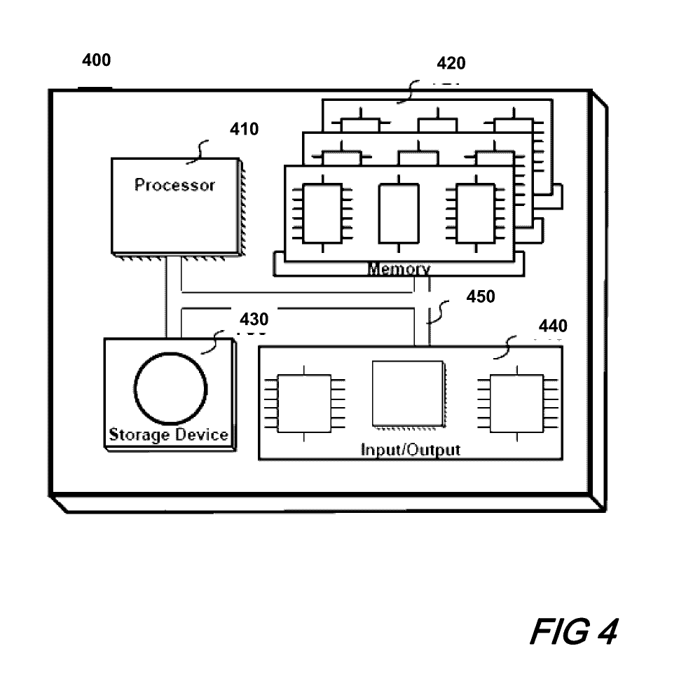

Finally, FIG. 4 shows an illustrative computer system 400 suitable for implementing methods and systems according to an aspect of the present disclosure. As may be immediately appreciated, such a computer system may be integrated into an another system such as a router and may be implemented via discrete elements or one or more integrated components. The computer system may comprise, for example a computer running any of a number of operating systems. The above-described methods of the present disclosure may be implemented on the computer system 400 as stored program control instructions.

Computer system 400 includes processor 410, memory 420, storage device 430, and input/output structure 440. One or more input/output devices may include a display 445. One or more busses 450 typically interconnect the components, 410, 420, 430, and 440. Processor 410 may be a single or multi core. Additionally, the system may include accelerators etc. further comprising the system on a chip.

Processor 410 executes instructions in which embodiments of the present disclosure may comprise steps described in one or more of the Drawing figures. Such instructions may be stored in memory 420 or storage device 430. Data and/or information may be received and output using one or more input/output devices.

Memory 420 may store data and may be a computer-readable medium, such as volatile or non-volatile memory. Storage device 430 may provide storage for system 400 including for example, the previously described methods. In various aspects, storage device 430 may be a flash memory device, a disk drive, an optical disk device, or a tape device employing magnetic, optical, or other recording technologies.

Input/output structures 440 may provide input/output operations for system 400 to one or more sensors/valves/relays/etc., that may be used to control and/or provide feedback to any chillers to which computer system 400 is communicatively coupled.

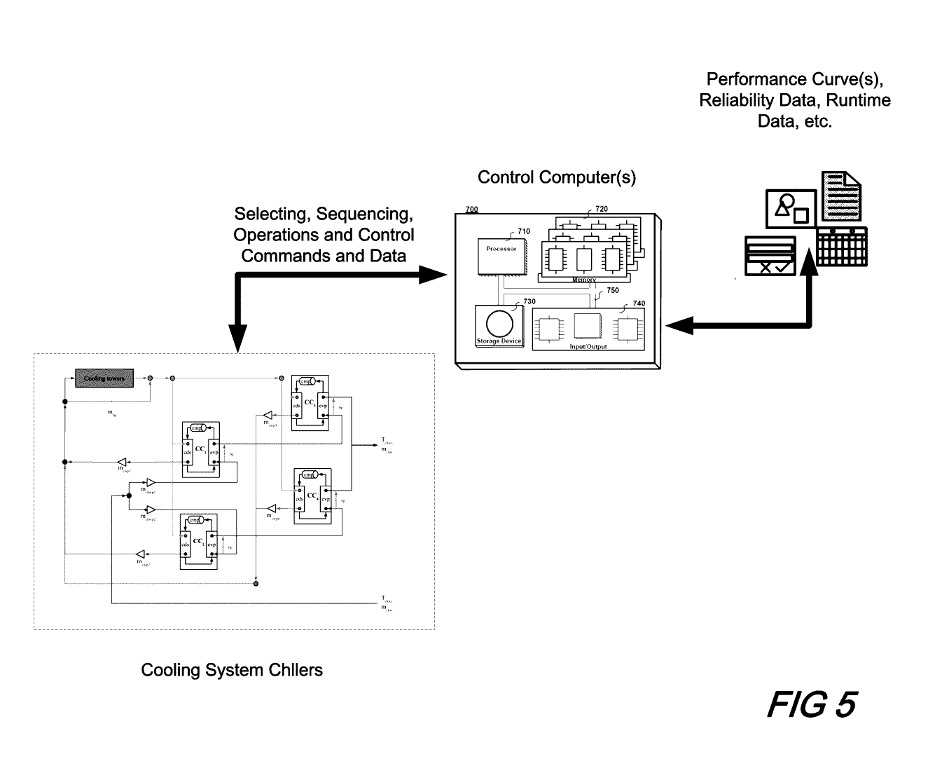

FIG. 5 is a schematic block diagram illustrating a computer system such as that shown in FIG. 4 controlling a chilling system including a plurality of chillers according to aspects of the present disclosure utilizing performance curves, cost(s) including installation and repair costs, reliability data of individual chillers, runtime data and rules.

At this point, while we have presented this disclosure using some specific examples, those skilled in the art will recognize that our teachings are not so limited. Accordingly, this disclosure should be only limited by the scope of the claims attached hereto.

1. A computer implemented method for selecting, sequencing and operating a plurality of chillers configured in a multi-chiller configuration, the method comprising:
collecting, by the computer, any cooling load forecast(s) including external/internal temperatures that may affect that forecast;
determining, by the computer, selection, sequencing and operation of the plurality of chillers chiller according to a sequencing and dispatch strategy selected from the group consisting of: performance curves based, minimum cost based, resilient operation based, and device runtime based; and
operating, by the computer, the plurality of chillers according to the sequencing and dispatch strategy so selected.

2. The computer implemented method of claim 1 wherein the performance curves based strategy includes determining individual chiller load to minimize energy consumption and sequencing selected chillers such that energy consumption is minimized.

3. The computer implemented method of claim 1 wherein the minimum cost based strategy includes determining individual chiller load based on performance curves, said curves being associated with particular chiller(s), and sequencing selected chillers such that installation and repair costs of the chillers are minimized.

4. The computer implemented method of claim 1 wherein the resilient operation based strategy includes determining individual chiller load based on performance curves, said curves being associated with particular chiller(s), and sequencing selected chillers such that reliable operation of the chillers are maximized.

5. The computer implemented method of claim 1 wherein the device runtime based strategy includes determining individual chiller load based on performance curves and sequencing selected chillers based on device runtime considerations including time of day, length of run, energy grid output.
